(19) United States
(12) Patent Application Publication
(10) Pub. No.: US 2009/0020452 A1
(43) Pub. Date: Jan. 22, 2009

(54) PALLETISED LOADS OF CONTAINERS

(75) Inventors: Hugh David Facey, Sheffield (GB); Derek Boaler, Sheffield (GB); John Makin, South Yorkshire (GB); Brian Edward Shawcross, Nottinghamshire (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: LOADHOG LIMITED, Sheffield (GB)

(21) Appl. No.: 11/573,963

(22) PCT Filed: Sep. 21, 2005
(86) PCT No.: PCT/GB2005/003615

§ 371 Date: Aug. 19, 2008

(30) Foreign Application Priority Data
Sep. 22, 2004 (GB) 0421022.5
Dec. 3, 2004 (GB) 0426516.1

(51) Int. Cl. F16G 11/03; F16G 11/00; B65B 13/22; B65D 19/38

(52) U.S. Cl. 206/597; 24/68 R; 24/68 CD

(57) ABSTRACT

A device for alleviating slackening of vertical strapping (24) in palletised loads of containers comprises a pair of rectangular frames (32, 33), spring means (34) between the frames urging them apart, and tethering means (47, 48) limiting separation of the frames, which device is preferably placed on top of a slip sheet (22Y) placed on the top layer (L) of containers, especially of bottles (20). The outer edges of the upper frame (32) preferably has shallow grooves (51) from its outer edges to accommodate the vertical strapping (24) and protect it from abrasion. The lower frame (33) preferably has a flared outer skirt (49) to assist in locating the device on a top slip sheet (22Y), and locating a plurality of such devices one on another for return transport.

This invention relates to palletised loads of containers, such as bottles or cans, in which the upright containers are stacked automatically in layers on a pallet (or a dolly) with slip sheets (also known as layer pads) e.g. of polypropylene of the order of 2.0 to 4.0 mm thickness, between the layers, and also one below the bottom layer, each successive slip sheet being placed on top of a layer of containers and each successive layer of containers being pushed laterally en masse or lowered from above on to the preceding slip sheet, the completed stack being topped-off by a slip sheet and a rigid board which is subjected to a downward loading, e.g. of 2 to 3 tonnes, to compact the layers and slip sheets whilst strapping is automatically applied vertically between the pallet and the board, across under the platform of the pallet (or dolly) and across the top of the board. The board is usually formed by four lengths of wood, e.g. each 97 mm wide and 17 mm thick, joined together to form a rectangle having outside dimensions commensurate with the dimensions of the pallet.

Upon arrival at the point of use, the vertical strapping is cut off, the rigid board and top slip sheet removed, and the height of the stack is adjusted so that each layer of containers can be pushed laterally en masse off the slip sheet below on to, e.g., a conveyor feeding a bottling or canning line.

Because the strapping, after securing ends together before removing the downward loading, is of finite length, any subsequent settling of the stack, e.g. due to variation in bottle height, e.g. plus or minus up to 1.0 mm, and/or vibration and/or stretching of the strapping, particularly arising from expansion due to temperature rise subsequent to the strapping operation results in loss of tension in the strapping that can lead to instability of the stack, especially as vibration of the palletised load during transporting can cause ‘boftle-walking’ (or ‘can-walking’) from within the confines of the slip sheets, hereinafter referred to simply as ‘walking’, with disastrous results, especially breaking of bottles, but also denting of cans.

It is, therefore, common practice to apply strapping horizontally around each layer of containers, but there still remains a tendency to ‘walking’ of a layer en masse from palletised loads, especially from loads disposed over wheels of a truck where vibration is particularly intense. It is also known to place on top of each layer a cardboard cap with sides to embrace the outermost containers adjacent their tops, as another attempt to prevent ‘walking’. Any sudden braking and/or impact, such as hitting kerbs or pot-holes, causes rapid destabilisation of the stack following any leading row of containers falling over the adjacent edge of the slip sheet below.

The object of the present invention is to provide devices for alleviating slacking of the vertical strapping by maintaining strapping tension.

According to one aspect of the present invention, a device for alleviating slackening of vertical strapping on palletised loads of containers as initially described comprises a pair of boards each of dimensions commensurate with the dimensions of a pallet or dolly on which containers are to be stacked in layers, spring means between the boards urging them apart, and tethering means limiting separation of the boards; the device being thereby adapted to be incorporated in such a stack of containers, the spring means being adapted to be compressed by downward loading of the stack during application of vertical strapping, and to expand to be effective to maintain tension in the strapping following any subsequent settling of the stack.

The device may be interposed between the pallet or dolly and the bottom layer of containers, or intermediate any two layers in the stack, but is preferably placed on the top layer so as not to cause any logistical problems with existing machinery for automatically placing or pushing on successive layers of containers.

Preferably, however, according to another aspect of the present invention, the device comprises a pair of rectangular frames each of outer dimensions commensurate with the dimensions of a pallet or dolly on which containers are to be stacked in layers, spring means between the frames urging them apart, and tethering means limiting separation of the frames. Again, this device may be interposed between the pallet or dolly and the bottom layer of containers, or intermediate any two layers in the stack, but is preferably placed on top of a slip sheet placed on the top layer.

Such a frame device may be collapsible (for more compact return transport with similar collapsible devices from dismantled loads); thus two (usually longer) sides may each be formed by two pairs of bars connected together by hinged links to fold inwardly, these bars also being connected by hinges to offshots on the other two sides which are each formed by two rigid bars, whereby the device can be collapsed to within an ‘envelope’ equal in length to any one of the rigid bars and of a width equal to four times the width of the bars, there being snap-action stop means between the hinged links and the bars and within the hinges to hold the extended sides rigid and square to the rigid bars. Some vertical play may be provided in the hinged links and the hinges, to enable vertical strapping to be applied first over the hinged sides without distorting or stressing the rigid sides to an extent tending to cause subsequent slackening of the strapping.

Alternatively, such a frame device is more economically manufactured by forming each frame in four parts, one for each side, all secured together at respective corners by tongue and slot connections and releasable means (such as screws) enabling the frames to be dismantled for compact transporting and/or cannibalising of damaged frames. All the parts are preferably provided with integral longitudinal flanges and ribs in the upper frame parts affording some stiffness, while allowing some flexing of the longer sides of the upper parts to enable vertical strapping to be applied first over the longer sides without distorting or stressing the shorter sides to an extent tending to cause subsequent slackening of the strapping.

The outer edges of at least the upper board or of the upper frame may be radiussed so as not to present sharp edges to vertical strapping; but, preferably the upper board or upper frame also has shallow grooves extending from the outer edges to accommodate the vertical strapping and protect it from abrasion.

The spring means may comprise elastomeric material bonded to both boards or frames (thus also serving as the tethering means) and having adequate ‘memory’ upon release of compressive loading; or it may comprise metallic springs, e.g. of stainless steel, such as leaf springs tethered to the boards or frames, or helical compression springs encircling or within telescoping projections on the mutual faces of the boards or frames, with stop means between the telescoping projections to serve as the tethering means and allow pre-stressing of the springs. Preferably, however, the spring means comprises conical coil compression springs, with upper end portions located round projections on the underside of the upper board or frame and lower end portions of each located in recesses in the upper sides of the lower board or frame, and with tethering means comprising slidable snap-engaging projections between the boards or frames; whereby, when compressed upon loading of the boards or frames, as aforesaid, the springs can lie flattened between the boards or frames, thus enabling a closer unloaded or loaded spacing of the boards or frames than is possible using helical compression springs of similar rating.

Either of the above devices may be formed mainly of plastics material, of suitable weight, strength, stiffness and colour, only the spring means and any screws preferably being of metal.

In addition to either of the above devices, a cap of the type claimed in WO-A-01/96203 may be provided on top of the stack, the hooks on its strapping strands engaged with the underside of the platform of the pallet (or a dolly), and the tensioning mechanisms operated to secure the load, without need of any non-reusable strapping. Alternatively, the upper board or upper frame (as the case may be) may carry cassettes housing the strapping strands, hooks and tensioning mechanisms.

For greater secureness against ‘walking’ of containers stacked in layers on a pallet or dolly, the stack preferably includes below the bottom layer, between successive layers and on top of the top layer slip sheets as described in Co-pending Application No. (Our Reference P/6775.GBP).

A preferred embodiment of the invention will now be described, by way of example only, with reference to the accompanying drawings, which also include diagrammatic prior art illustrations used to explain the problem solved by the invention.

In the drawings:—

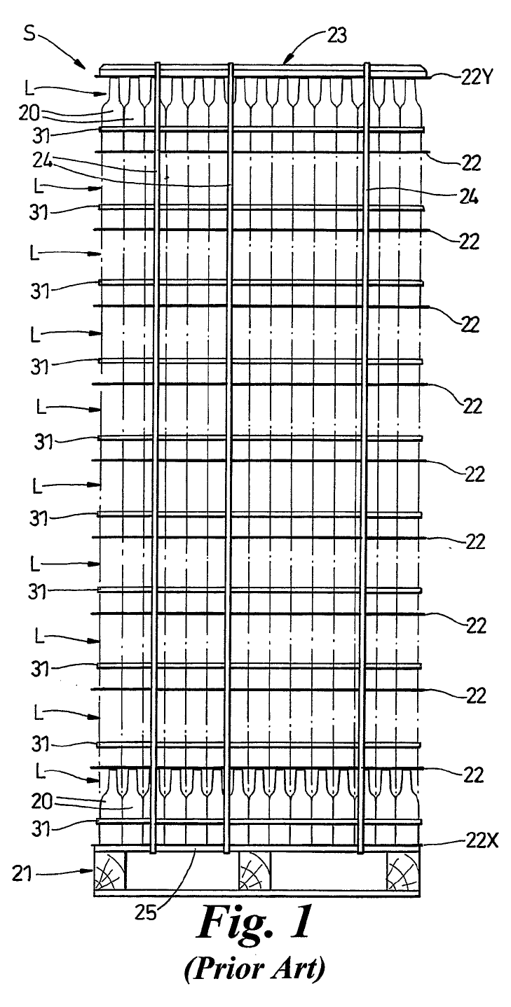

FIG. 1 is an end elevation of a palletised load of bottles in accordance with a prior art method of stacking them on and strapping them to a pallet;

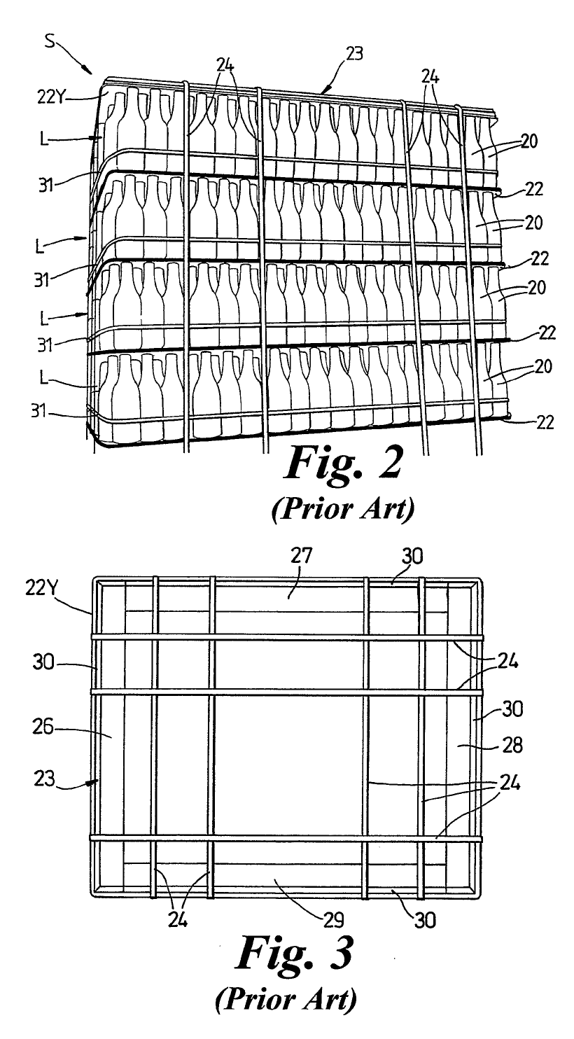

FIG. 2 is a fragmentary view from one side of the top four layers of bottles of FIG. 1;

FIG. 3 is a plan view of the palletised load;

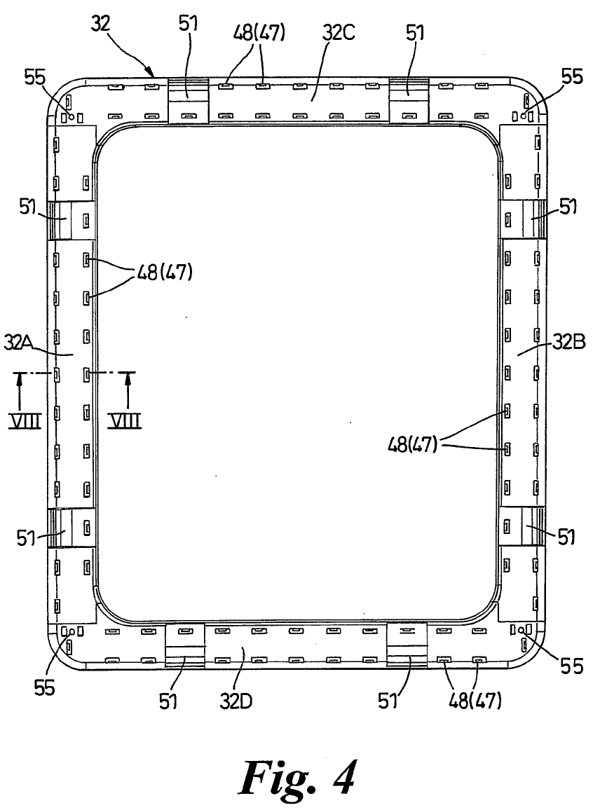

FIG. 4 is a plan view of a frame device in accordance with the invention;

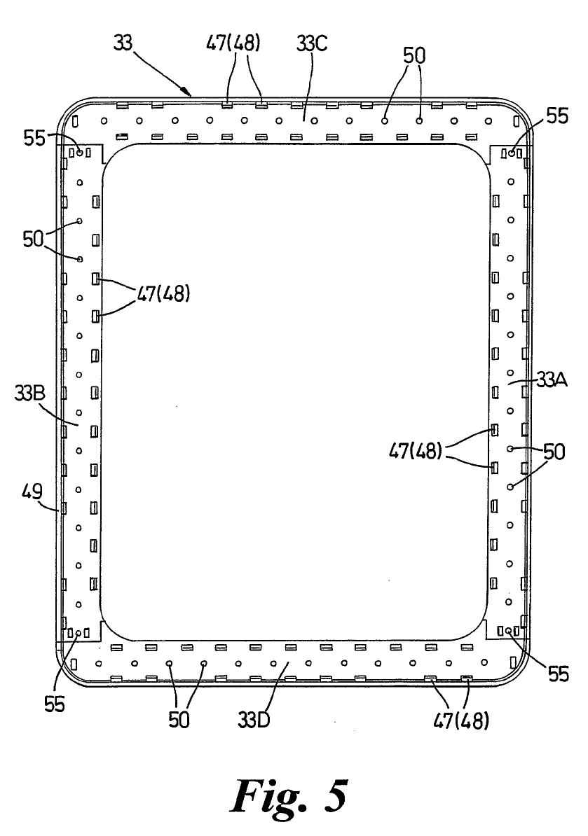

FIG. 5 is an underneath plan of the frame device of FIG. 4;

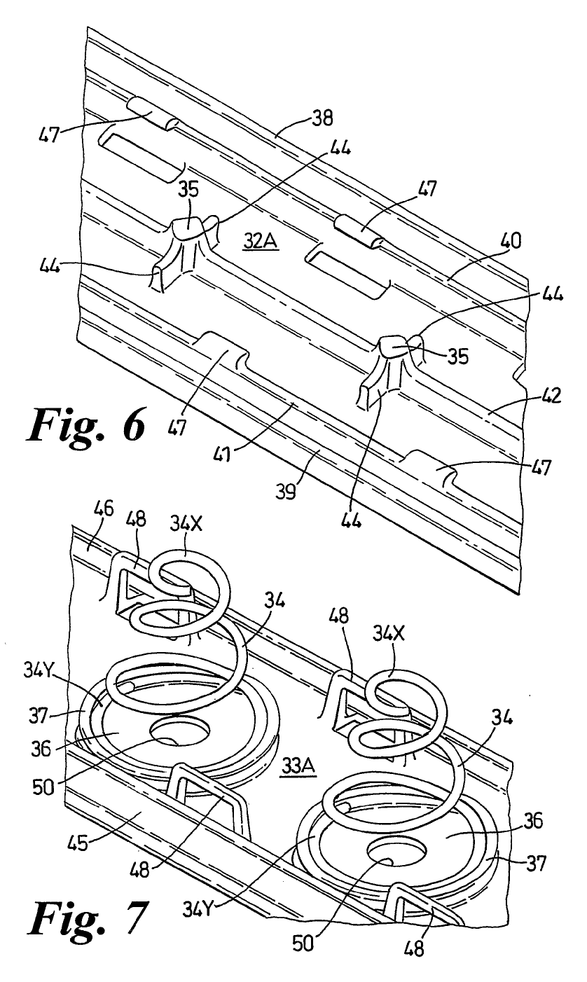

FIG. 6 is a fragmentary view of part of the underside of one of the upper frame parts;

FIG. 7 is a fragmentary view of a corresponding part of the upper side of one of the lower frame parts;

FIG. 8 is a section from the line VIII-VIII in FIG. 4 in the as-assembled condition of the frame;

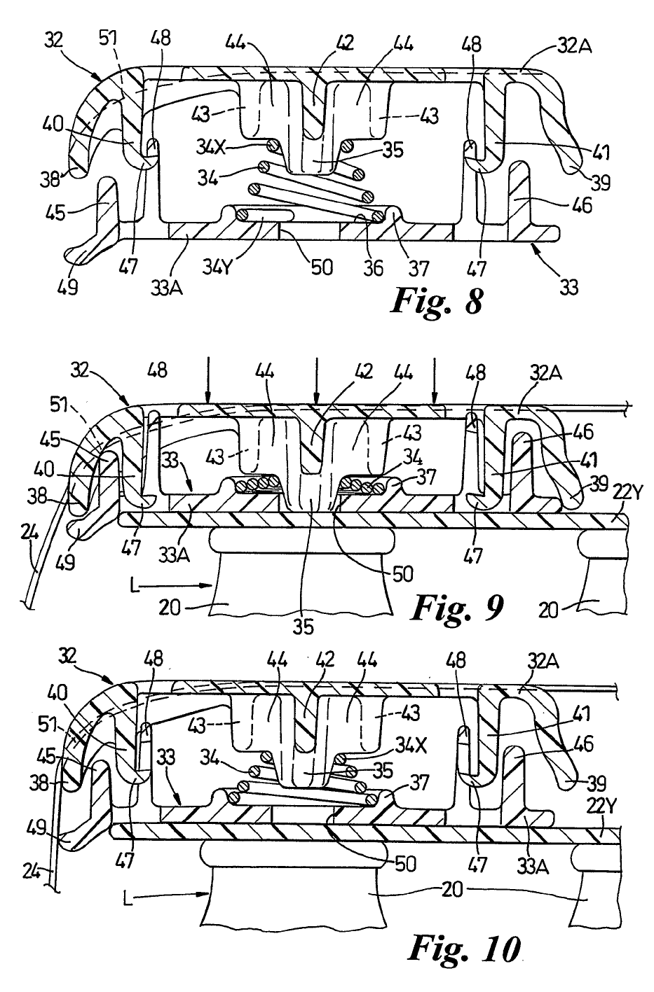

FIG. 9 corresponds to FIG. 8 with fragmentary additions of a top layer of bottles in a stack, a slip sheet thereon, and strapping during application of the latter whilst downward loading is applied to the frame device;

FIG. 10 corresponds to FIG. 9 but shows the condition of the frame device after the strapping has been secured and the downward loading removed; and

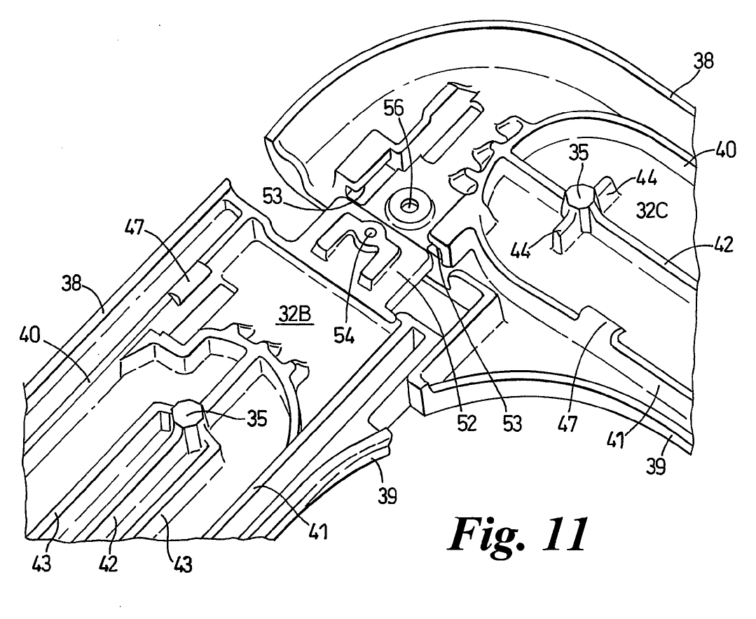

FIG. 11 is a fragmentary view of mating parts at the ends of two upper frame parts.

Referring to prior art FIGS. 1 to 3, this invention relates to palletised loads of containers, such as bottles 20 (as shown) or cans, in which the upright containers are stacked automatically in layers L on a pallet 21 (or a dolly) with slip sheets 22 (also known as layer pads), e.g. of polypropylene of the order of 2.0 to 4.0 mm thickness, between the layers, and also one 22X below the bottom layer, each successive slip sheet being placed on top of a layer of containers and each successive layer of containers being pushed en masse or lowered from above on to the preceding slip sheet, the completed stack S being topped-off by a slip sheet 22Y and a rigid board 23 which is subjected to a downward loading, e.g. of 2 to 3 tons, by means not shown, to compact the layers and slip sheets whilst strapping 24 is automatically applied vertically, by means not shown, between the pallet 21 and the board 23, across under the platform 25 of the pallet and across the top of the board.

As indicated by FIG. 3, the board 23 is usually formed by four lengths of wood 26, 27, 28, 29, e.g. each 97 mm wide and 17 mm thick, joined together to form a rectangle having outside dimensions commensurate with the dimensions of the pallet. The upper outer edges 30 of the board are bevelled (as shown) or rounded to reduce high stress points in the strapping 24.

Because the strapping 24, after securing ends together (not shown) before removing the downward loading, is of finite length, any subsequent settling of the stack S, e.g. due to variation in bottle height, e.g. plus or minus up to 1.0 mm, and/or vibration and/or stretching of the strapping 24, especially resulting from temperature rise subsequent to the strapping operation results in loss of tension in the strapping that can lead to instability of the stack, especially as vibration or shock loading of the palletised load during transport can cause ‘bottle-walking’ (or ‘can-walking’) from within the confines of the slip sheets 22, with disastrous results, especially breaking of bottles.

It is, therefore, as shown in FIGS. 1 and 2, common practice to apply strapping 31 horizontally around each layer L of containers 20, but there still remains a tendency to ‘walking’ or slipping of a layer en masse from a palletised load.

Therefore, by replacing the board 23 by a device according to the present invention, and preferably the frame device now to be described with reference to FIGS. 4 to 11, especially FIGS. 8 to 10, slackening of the vertical strapping is alleviated.

The device shown in FIGS. 4 and 5 comprises upper and lower frames 32, 33 respectively having outside dimensions similar to those of the board 23, i.e. commensurate with the dimensions of the pallet 21. The upper frame 32 is formed by four parts 32A, 32B, 32C, 32D, the parts 32A, 32B being identical and the parts 32C, 32D being identical, the ends of the parts 32A, 32B being secured to respective ends of the parts 32C, 32D in a manner to be described presently with reference to FIG. 11. The lower frame 33 is similarly formed by four parts 33A, 33B, 33C, 33D, the parts 33A, 33B being identical and the parts 33C, 33D, being identical, the ends of the parts 33A, 33B being secured to respective ends of the parts 33C, 33D in similar manner to the parts of upper frame 32. The device also comprises forty-eight conical coil compression springs 34 (SEE FIGS. 7 to 10).

Referring now to FIGS. 6 to 10, the smaller upper end portions 34X of each spring 34 locates round a projection 35 on the underside of an upper frame part (32A, etc) while the larger lower end portion 34Y locates in a recess 36 in the upper side of a lower frame part (33A, etc) formed by an annular rib 37.

All the upper frame parts are provided with outer and inner flanges 38, 39 respectively, outer and inner longitudinal ribs 40, 41 respectively, and a central longitudinal rib 42, while the upper frame parts 32A, 32B also have additional longitudinal ribs 43 one to each side of the central rib. Short ribs 44 are provided either side of the central rib 42 where the projections 35 are located.

All the lower frame parts are provided with outer and inner flanges 45, 46 respectively disposed between the outer flange 38 and outer rib 40 and between the inner flange 39 and inner rib 41 respectively of the upper frame parts.

The ribs 40, 41 of the upper frame parts are provided with claws 47 for snap engagement with the crossbars of goalpost-like upstanding formations 48 on the lower frame parts, as shown in FIG. 8, to effect a pre-compression of the springs 34, and to restrict the height of the device for compactness during return transport.

The lower frame parts also have a flared outer skirt 49 to assist in locating the device on a slip sheet 22Y, as shown in FIG. 9, on top of the top layer of bottles 20 in a stack as aforesaid, and locating a plurality of devices one on another for return transport. When downward loading is applied to the device, as indicated by the three arrows, to enable vertical strapping 24 to be applied, the upper frame 32 moves towards the lower frame 33, flattening the springs 34, until the central ribs 42 contact the annular rib 37, whereafter the downward loading is transmitted to the stack of bottles to compact it. The projections 35 are accommodated in holes 50 in the lower frame parts (see also FIG. 5).

After securing the vertical strapping 24 while maintaining the downward loading, the loading is then removed. On removal of the loading the springs 34 apply upward pressure on the strapping through the upper frame 32, thereby increasing the tension in the strapping, by anything up to 50%. Any subsequent slackening of the vertical strapping is taken up by some further expanding of the springs 34, as indicated by the position of the frames 32, 33 and springs 34 in FIG. 10, thus maintaining stability of the stack of bottles.

The upper frame 32 has shallow grooves 51 (see FIGS. 4 and 8 to 10) from its outer edges to accommodate the vertical strapping 24 and protect it from abrasion.

As indicated by FIG. 11 the parts of the upper frame 32 (and likewise of the lower frame 33) are secured together by tongues 52 and slots 53, which tongues are provided with holes 54 into which screws 55 (see FIGS. 4 and 5) are driven through holes 56 in the mating parts.

The distribution of the springing amongst the forty-eight springs 34 affords a very considerable total spring force with relatively low-rated springs and is also advantageous in equalising tension in vertical strapping 24. Other advantages lie in eliminating changes in tension in vertical strapping during transportation, enabling a reduction in the number of vertical strapping bands required to secure a load and/or an increase in the number of layers of containers thereby reducing transportation costs, and eliminating changes in tension in vertical strapping arising from expansion due to temperature rise subsequent to the strapping operation.

According to a further aspect of the present invention, a palletised load of containers comprises upright containers stacked in layers on a pallet or dolly with slip sheets between the layers, also one below the bottom layer, the completed stack being topped-off by another slip sheet and a device in accordance with any one of the previous aspects of the invention, and strapping applied vertically between the pallet or dolly and the device, across under the platform of the pallet or dolly and across the top of the device whilst subjected to a downward loading, whereby, after removal of the downward loading of the spring means in the device maintains strapping tension.

According to yet another aspect of the present invention, each slip sheet comprises a flat rectangular board having diverging marginal portions, e.g., as in any one of the aspects of the invention in Co-pending Application No. (Our Reference P/6775.GBP), creating between successive slip sheets a ‘throat’ preventing ‘walking’ of the containers from between the slip sheets or slipping upon shock loading.

1. A device for alleviating slackening of vertical strapping (24) on palletised loads of containers (20) comprising a pair of boards (32,33) each of dimensions commensurate with the dimensions of a pallet (21) or dolly on which containers (20) are to be stacked in layers (L), spring means (34) between the boards urging them apart, and tethering means (47,48) limiting separation of the boards.

2. A device for alleviating slackening of vertical strapping (24) on palletised loads of containers (20) comprising a pair of rectangular frames (32,33) each of outer dimensions commensurate with the dimensions of a pallet (21) or dolly on which containers (20) are to be stacked in layers (L), spring means between the frames urging them apart, and tethering means (47,48) limiting separation of the frames.

3. A device as in claim 2 characterized in that it is collapsible.

4. A device as in claim 3, wherein two sides are each formed by two pairs of bars connected together by hinged links to fold inwardly, these bars also being connected by hinges to offshots on the other two sides which are each formed by two rigid bars, whereby the device can be collapsed to within an ‘envelope’ equal in length to any one of the rigid bars and of a width equal to four times the width of the bars, there being snap-action stop means between the hinged links and the bars and within the hinges to hold the extended sides rigid and square to the rigid bars.

5. A device as in claim 4, wherein some vertical play is provided in the hinged links and the hinges, to enable vertical strapping to be applied first over the hinged sides without distorting or stressing the rigid sides to an extent tending to cause subsequent slackening of the strapping.

6. A device as in claim 2, characterized in that each frame (32,33) is formed in four parts (32A . . . 32D,33A . . . 33D), one for each side, all secured together at respective corners by tongue (52) and slot (53) connections and releasable means (55) enabling the frames to be dismantled for compact transporting and/or repair, refurbishment or cannibalising of damaged frames.

7. A device as in claim 6, wherein the releasable means are screws (55).

8. A device as in claim 7, wherein all the parts (32A . . . 32D,33A . . . 33D) are provided with integral longitudinal flanges (38,39,45,46) and ribs (40,41,42) in the upper frame parts (32A . . . 32D) affording some stiffness, while allowing some flexing of longer sides of the upper parts to enable vertical strapping (24) to be applied first over the longer sides without distorting or stressing the shorter sides to an extent tending to cause subsequent slackening of the strapping.

9. A device as in any one of claims 1 to 8, wherein the outer edges of at least the upper board or of the upper frame (32) are radiussed so as not to present sharp edges to vertical strapping (24).

10. A device as in any one of claims 1 to 9, wherein the upper board or upper frame (32) has shallow grooves (51) extending from the outer edges to accommodate the vertical strapping (24) and protect it from abrasion.

11. A device as in any one of claims 1 to 10, wherein the spring means comprises elastomeric material bonded to both boards or frames (32,33), so as also to serve as the tethering means, and having adequate ‘memory’ upon release of compressive loading.

12. A device as in any one of claims 1 to 10, wherein the spring means comprises metallic springs (34).

13. A device as in claim 12, wherein leaf springs are tethered to the boards or frames.

14. A device as in claim 12, wherein helical compression springs encircle or are provided within telescoping projections on the mutual faces of the boards or frames, with stop means between the telescoping projections to serve as the tethering means and allow pre-stressing of the springs.

15. A device as in claim 12, wherein conical coil compression springs (34) are provided, with upper end portions (34X) located round projections (35) on the underside of the upper board or frame (32) and lower end portions (34Y) of each located in recesses (36) in the upper sides of the lower board or frame (33), and with tethering means comprising slidable snap-engaging projections (47,48) between the boards or frames; whereby, when compressed upon loading of the boards or frames (32,33), as aforesaid, the springs (34) can lie flattened between the boards or frames, thus enabling a closer unloaded spacing of the boards or frames than is possible using helical compression springs of similar rating.

16. A device as in any one of claims 1 to 15 formed mainly of plastics material, of suitable weight, strength, stiffness and colour.

17. A device as in any one of claims 1 to 16, wherein the upper board or upper frame carries cassettes housing strapping strands, hooks and tensioning mechanisms for securing a palletised load of containers on a pallet or dolly by engaging the hooks with the underside of the platform of the pallet or dolly.

18. A device for alleviating slackening of vertical strapping on palletised loads of containers substantially as hereinbefore described with reference to FIGS. 4 to 11 of the accompanying drawings.

19. A palletised load of containers comprising upright containers (20) stacked in layers (L) on a pallet (21) or dolly with slip sheets (22) between the layers, also one (22X) below the bottom layer, the completed stack(s) being topped-off by another slip sheet (22Y) and a device (32,33) as in any one of the preceding claims, and strapping (24) applied vertically between the pallet (21) or dolly and the device, across under the platform (25) of the pallet or dolly and across the top of the device whilst subjected to a downward loading, whereby, after removal of the downward loading the spring means (34) in the device maintains strapping tension.

20. A palletised load of containers as in claim 19, wherein each slip sheet comprises a flat rectangular board having diverging marginal portions creating between successive slip sheets a ‘throat’ preventing ‘walking’ of the containers from between the slip sheets or slipping upon shock loading
